(19) United States
(12) Patent Application Publication
(10) Pub. No.: US 2016/0026955 A1
(43) Pub. Date: Jan. 28, 2016

(54) SYSTEMS AND METHODS FOR FACIILTY LINES FORECASTING

(71) Applicant: Caterpillar Inc., Peoria, IL (US)

(72) Inventors: Sridhar RAMASWAMY, Naperville, IL (US); Ryan Lee STETZLER, Normal, IL (US); Faisal HASAN, Dunlap, IL (US); Matthew Allen PERVA, Washington, IL (US)

(73) Assignee: Caterpillar Inc., Peoria, IL (US)

(21) Appl. No.: 14/339,553

(22) Filed: Jul. 24, 2014

(51) Int. Cl. G06Q 10/06; G06N 5/04

(52) U.S. Cl. CPC G06Q 10/06315; G06N 5/048

(57) ABSTRACT

Systems and methods are disclosed for forecasting lines in a facility network. The computer system includes at least one processor configured with instructions to collect data associated with each facility, the collected data including historical inbound pieces from each upstream facility of each facility. The at least one processor forecasts, for each facility, total inbound pieces to be received by that facility. The at least one processor also forecasts, for each facility, inbound pieces to be received by that facility from each upstream facility of that facility based on the total inbound pieces received by that facility. The at least one processor further forecasts, for each facility, total inbound lines to be received by that facility, based on the historical and forecasted inbound pieces received by that facility from each upstream facility of that facility.

### TECHNICAL FIELD

This disclosure relates generally to forecasting methods and systems and, more particularly, to forecasting methods and systems for forecasting facility lines in a facility network.

### BACKGROUND

Today's business organizations often use a coordinated facility network of people, activities, information, and resources to move items from point to point. Entities involved in such network typically include suppliers, distributing facilities, dealers, end customers, and the like. An effective service and operation planning on such network may be essential to the success of many of today's business organizations. The service and operation planning typically involves a plurality of interrelated processes that forecast inter-facility lines (i.e., volumes of products transferred between facilities), and plan future manpower or other resources based on the forecasted inter-facility lines. Thus, accurate forecasting of the inter-facility lines is desired.

U.S. Patent Publication No. 2008/0015884 (the '884 publication) to Jamula is directed to systems and methods for providing operational information in a first shipping facility at a first location that receives items from at least one second shipping facility at a second location. In particular, the '884 publication discloses a method including collecting facility processing data representative of activities at the first shipping facility, collecting shipping data representative of activities at a second shipping facility, and determining operational information from the facility processing data and the shipping data. The method of the '884 publication determines the shipping data based on items being shipped from the second shipping facility to the first shipping facility. However, the method of the '884 publication does not forecast future items to be shipped from the second shipping facility. Thus, the shipping data provided by the method of the '884 publication may not represent future activities of the second shipping facility. Consequently, the method of the '884 publication may not provide future operation information of the first shipping facility.

The disclosed methods and systems are directed to solve one or more of the problems set forth above and/or other problems of the prior art.

### SUMMARY

In one aspect, the present disclosure is directed to a computer system for forecasting lines in a facility network. The computer system includes at least one processor configured with instructions to collect data associated with each facility, the collected data including historical inbound pieces from each upstream facility of each facility, historical total inbound lines of each facility, and historical and future demand, sales, inventory, and receipt data of each facility. The at least one processor is also configured with instructions to forecast, for each facility, total inbound pieces to be received by that facility, based on the historical total inbound lines of that facility, and the historical and future demand, sales, inventory, and receipt data of that facility. The at least one processor is also configured with instructions to forecast, for each facility, inbound pieces to be received by that facility from each upstream facility of that facility, based on the forecasted total inbound pieces of that facility, the historical inbound pieces from each upstream facility of that facility, and the historical and future demand, sales, inventory, and receipt data of that facility. The at least one processor is further configured with instructions to forecast, for each facility, total inbound lines to be received by that facility, based on the historical and forecasted inbound pieces received by that facility from each upstream facility of that facility, and the historical and future demand, sales, inventory, and receipt data of that facility.

In one aspect, the present disclosure is directed to a method for forecasting lines in a facility network. The method includes collecting data associated with each facility, the collected data including historical inbound pieces from each upstream facility of each facility, historical total inbound lines of each facility, and historical and future demand, sales, inventory, and receipt data of each facility. The method also includes forecasting, for each facility, total inbound pieces to be received by that facility, based on the historical total inbound lines of that facility, and the historical and future demand, sales, inventory, and receipt data of that facility. The method also includes forecasting, for each facility, inbound pieces to be received by that facility from each upstream facility of that facility, based on the forecasted total inbound pieces of that facility, the historical inbound pieces from each upstream facility of that facility, and the historical and future demand, sales, inventory, and receipt data of that facility. The method further includes forecasting, for each facility, total inbound lines to be received by that facility, based on the historical and forecasted inbound pieces received by that facility from each upstream facility of that facility, and the historical and future demand, sales, inventory, and receipt data of that facility.

In one aspect, the present disclosure is directed to a computer system for forecasting lines in a facility network. The computer system includes at least one processor configured with instructions to collect data associated with each facility, the collected data of each facility including historical inbound pieces from each upstream facility of that facility, historical total outbound non-revenue lines of that facility, and historical and future demand, sales, inventory, and receipt data of that facility. The at least one processor is also configured with instructions to forecast, for each facility, total inbound pieces to be received by that facility, based on the historical total inbound lines of that facility, and the historical and future demand, sales, inventory, and receipt data of that facility. The at least one processor is also configured with instructions to forecast, for each facility, inbound pieces to be received by that facility from each upstream facility of that facility, based on the forecasted total inbound pieces of that facility, the historical inbound pieces from each upstream facility of that facility, and the historical and future demand, sales, inventory, and receipt data of that facility. The at least one processor is also configured with instructions to calculate, for each facility, historical and future outbound pieces from that facility to each downstream facility of that facility based on the historical and forecasted inbound pieces received by each downstream facility from that facility. The at least one processor is also configured with instructions to forecast, for each facility, total outbound non-revenue lines of that facility, based on the historical and future outbound pieces from that facility to each downstream facility, the historical total outbound non-revenue lines of that facility, and the historical and future demand, sales, inventory, and receipt data of that facility.

### BRIEF DESCRIPTION OF THE DRAWINGS

FIG. 1 illustrates an exemplary facility network of a business organization in which a lines forecasting system consistent with the disclose embodiment may be implemented.

FIG. 2 illustrates an exemplary lines forecasting system consistent with a disclosed embodiment.

FIG. 3 illustrates a flowchart of a process of forecasting lines according to a disclosed embodiment.

FIG. 4 illustrates a flowchart of an exemplary process of forecasting total inbound pieces to be received by a facility, according to a disclosed embodiment.

FIG. 5 illustrates a flowchart of an exemplary process of forecasting inbound pieces to be received by a facility from each upstream facility, according to a disclosed embodiment.

FIG. 6 illustrates a flowchart of an exemplary process of forecasting total inbound lines to be received by a facility, according to a disclosed embodiment.

FIG. 7 illustrates a flowchart of an exemplary process of forecasting total outbound non-revenue lines to be sent from facility A, according to a disclosed embodiment.

FIG. 8 illustrates a flowchart of an exemplary process of forecasting total outbound revenue lines to be sent from facility A, according to a disclosed embodiment.

### DETAILED DESCRIPTION

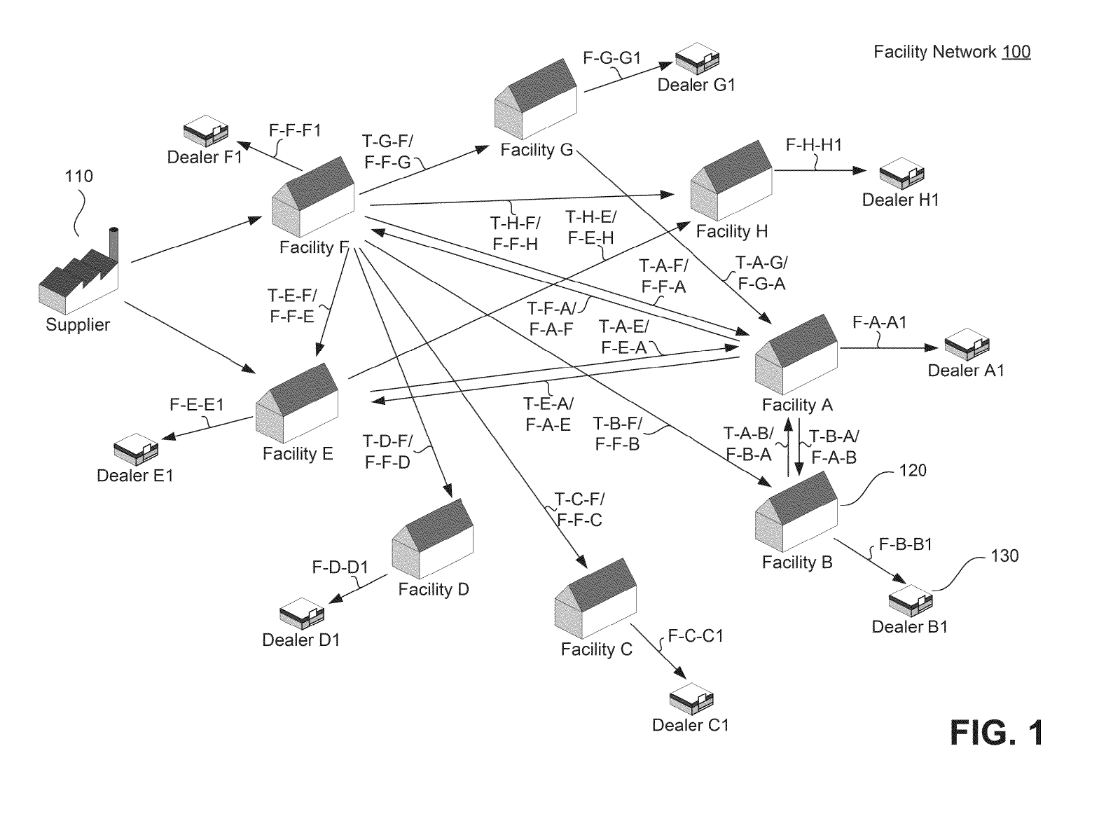

FIG. 1 illustrates an exemplary facility network 100 (hereinafter referred to as “network 100”) of a business organization in which the lines forecasting system consistent with the disclosed embodiment may be implemented. As shown in FIG. 1, network 100 may include a supplier 110, a plurality of facilities 120, and a plurality of dealers 130.

Supplier 110 may supply individual products to one or more of the plurality of facilities 120 (referred to as “entry points”). The products may be any type of physical good that is designed, developed, manufactured, assembled, and/or delivered by supplier 110. In some embodiments, the products may be parts, i.e., a physical component, of a prime product such as, for example, a machine, a piece of equipment, a vehicle, an aircraft, a locomotive, etc., manufactured by the business organization. Non-limiting examples of parts may include drive trains, engines, ground engaging tools, hydraulics, electronics, fluid and filters, undercarriages, and others. Although network 100 in FIG. 1 includes only one supplier 110, those skilled in the art will appreciate that network 100 may include more than one supplier.

The plurality of facilities 120 may include facilities A, B, . . . H that are located at different geographic locations. Each of facilities A, B, . . . H may be a warehouse that stores products received from supplier 110 or received from one or more of other facilities in network 100 (hereinafter referred to as “upstream facilities”). Each of facilities A, B, . . . H may also distribute the stored products to one or more of dealers 130 or other facilities in network 100 (hereinafter referred to as “downstream facilities”). As illustrated in FIG. 1, facilities E and F are entry points that receive products from supplier 110. Each of facilities A, B, . . . H may have at least one upstream facility. Some facilities, i.e., facilities C, D, and H, may not have any downstream facility. That is, facilities C, D, and H may only distribute products to their respective dealers. Although network 100 in FIG. 1 includes facilities A, B, . . . H, those skilled in the art will appreciate that network 100 may include any number of facilities.

Dealers 130 may include dealers A1, B1, . . . H1 that are located remotely from facilities A, B, . . . H. Dealers A1, B1, . . . H1 may receive products from facilities A, B, . . . H, respectively, for sale to customers (not shown in FIG. 1). Although network 100 in FIG. 1 includes only one dealer for each facility, those skilled in the art will appreciate that network 100 may include more than one dealer from each facility.

Facilities A, B, . . . H may receive or deliver products between each other via various inter-facility transfer links. For each facility, an inter-facility transfer link may be either an inbound link or a non-revenue outbound link (i.e., a link that does not generate revenue). Hereinafter, an inbound link for a facility X (X being any one of A, B, . . . H) from a facility Y (Y being any one of A, B, . . . H except X) may be referred to as T-X-Y, representing “to facility X from facility Y.” A non-revenue outbound link for facility X to facility Y is referred to as F-X-Y, representing “from facility X to facility Y.”

For example, as illustrated in FIG. 1, facility A may receive products from its upstream facilities B, E, F, and G, via inbound links represented T-A-B, T-A-E, T-A-F, and T-A-G, respectively; and facility A may also deliver products to its downstream facilities B, E, and F, via non-revenue outbound links represented by F-A-B, F-A-E, and F-A-F, respectively. Similarly, facility B may receive products from its upstream facilities A and F via inbound links represented by T-B-A and T-B-F, respectively; and facility B may also deliver products to its downstream facility A via a non-revenue outbound link represented by F-B-A. The inbound and non-revenue outbound links for facilities C, D, . . . H are similarly defined as those of facilities A and B. Therefore, a separate description of the inbound and non-revenue outbound links for facilities C, D, . . . H is not provided.

Facilities A, B, . . . H may deliver products to dealers A1, B1, . . . H1 via revenue outbound links (i.e., lines that generate revenue). For example, as illustrated in FIG. 1, facility A may deliver products to dealer A1 via revenue outbound link F-A-A1; facility B may deliver products to dealer B1 via revenue outbound link F-B-B1; and so on.

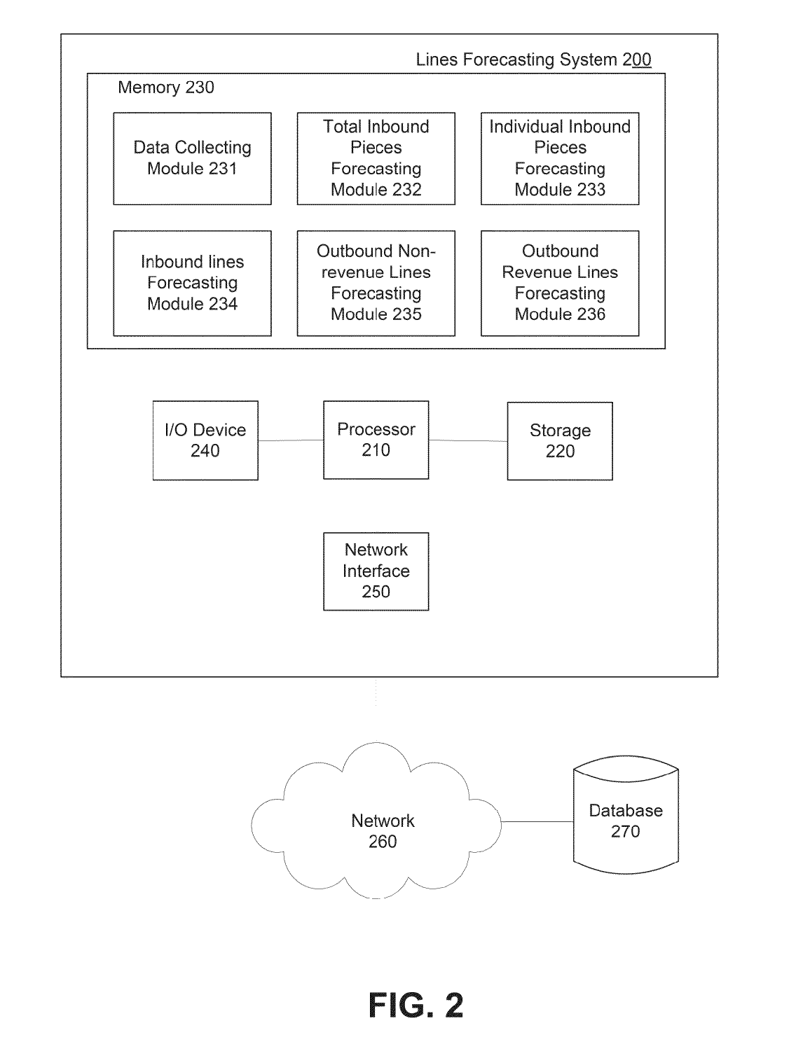

FIG. 2 illustrates an exemplary lines forecasting system 200 (hereinafter referred to as “system 200”) consistent with a disclosed embodiment. Lines forecasting system 200 may include one or more hardware and/or software components configured to display, collect, store, analyze, distribute, report, process, record, and/or sort information related to lines forecasting. In one embodiment, lines forecasting system 200 may be configured to forecast, for each one of facilities A, B, . . . H in network 100, total inbound pieces of products, total inbound lines, and total outbound non-revenue lines. A line, as used herein, may represent a unit volume of products that is transferred via a certain transfer link. For example, a facility may receive 1000 inbound pieces of products, which may take up 750 units volumes, i.e., 750 lines.

System 200 may include one or more of a processor 210, a storage unit 220, a memory 230, an input/output (I/O) device 240, and a network interface 250. System 200 may be connected via a network 260 to a database 270. In addition, system 200 may be connected via network 260 to one or more client terminals (not shown in FIG. 2) located remotely from system 200.

System 200 may be a server, client, mainframe, desktop, laptop, network computer, workstation, personal digital assistant (PDA), tablet PC, or the like. In one embodiment, system 200 may be a computer located in any one of facilities A, B, . . . H. In addition, one or more constituent components of system 200 may be co-located with supplier 110.

Processor 210 may include one or more processing devices. For example, processor 210 may include one or more microprocessors from the Pentium® or Xeon® family manufactured by Intel®, the Turion® family manufactured by AMD®, or any other type of processors. As shown in FIG. 2, processor 210 may be communicatively coupled to storage unit 220, memory 230. I/O device 240, and network interface 250. Processor 210 may be configured to execute computer program instructions to perform various processes and method consistent with certain disclosed embodiments. In one exemplary embodiment, computer program instructions may be stored in storage unit 220, and may be loaded into memory 230 for execution by processor 210.

Storage unit 220 may include a volatile or non-volatile, magnetic, semiconductor, tape, optical, removable, nonremovable, or other type of storage device or computer-readable medium. Storage unit 220 may store programs and/or other information that may be used by system 200. In one embodiment, storage unit 220 may store data collected from database 270.

Memory 230 may include one or more storage devices configured to store information used by system 200 to perform certain functions related to the disclosed embodiments. In one embodiment, memory 230 may include one or more modules (e.g., collections of one or more programs or subprograms) loaded from storage unit 220 or elsewhere that perform (i.e., that when executed by processor 210, enable processor 210 to perform) various procedures, operations, or processes consistent with the disclosed embodiment.

For example, memory 230 may include a data collecting module 231, a total inbound pieces forecasting module 232, an individual inbound pieces forecasting module 233, an inbound lines forecasting module 234, an outbound non-revenue lines forecasting module 235, and an outbound revenue lines forecasting module 236. Data collecting module 231 may enable processor 210 to collect data related to lines forecasting. Total inbound pieces forecasting module 232 may enable processor 210 to forecast, for each facility, a total number of inbound pieces of products (hereinafter referred to as “total inbound pieces”) to be received from all of its upstream facilities. Individual inbound pieces forecasting module 233 may enable processor 210 to forecast, for each facility, the number of inbound pieces of products (hereinafter referred to as “inbound pieces”) to be received from each one of its upstream facilities. Inbound lines forecasting module 234 may enable processor 210 to forecast, for each facility, the total inbound lines to be received from all of its upstream facilities. Outbound non-revenue lines forecasting module 235 may enable processor 210 to forecast, for each facility, the total outbound non-revenue lines (i.e., lines that do not immediately generate revenue) to be sent from that facility to all of its downstream facilities. Outbound revenue lines forecasting module 236 may enable processor 210 to forecast, for each facility, the total outbound revenue lines (i.e., lines that immediately generate revenue) to be sent from that facility to its dealer.

I/O device 240 may include one or more components configured to communication information associated with system 200. For example, I/O device 240 may include a console with an integrated keyboard and mouse to allow a user to input parameters associated with system 200 and/or data associated with lines forecasting. I/O device 240 may include one or more displays or other peripheral devices, such as, for example, printers, cameras, microphones, speaker systems, electronic tablets, bar code readers, scanners, or any other suitable type of I/O device 240. For example, I/O device 240 may include a display that displays forecasted inbound and outbound lines (including both revenue and non-revenue) for a facility in a format chosen by a user, such as, for example, table, graph, etc.

Network interface 250 may include one or more components configured to transmit and receive data via network 260, such as, for example, one or more modulators, demodulators, multiplexers, de-multiplexers, network communication devices, wireless devices, antennas, modems, and any other type of device configured to enable data communication via any suitable communication network. Network interface 250 may also be configured to provide remote connectivity between processor 210, storage unit 220, memory 230, and I/O device 240, and a remote client terminal to collect, analyze, and distribute data or information associated with lines forecasting.

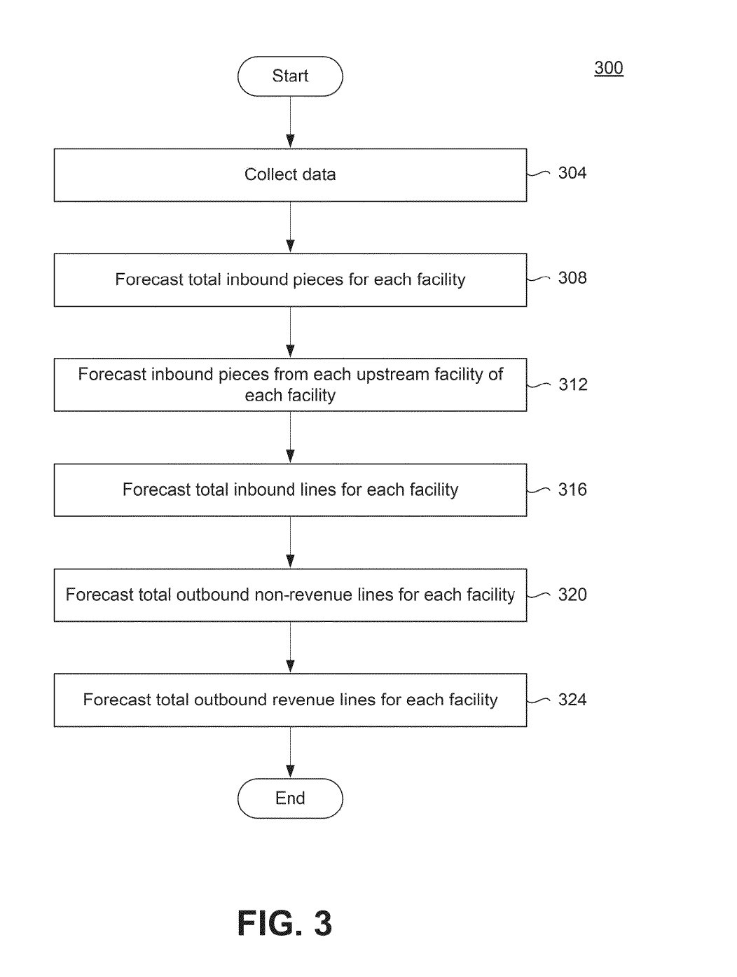

The operation of processor 210 in system 200 will now be described in connection with FIG. 3, which illustrates a flowchart of a process 300 of lines forecasting implemented by processor 210 according to a disclosed embodiment. Referring to FIG. 3, processor 210 may first collect data for lines forecasting (step 304). Processor 210 may collect, for each one of facilities A, B, . . . H in network 100, historical inbound pieces from each upstream facility, historical outbound pieces to each downstream facility and dealer, historical total inbound lines, historical total outbound non-revenue lines, and historical total outbound revenue lines of that facility. Processor 210 may also collect historical and future demand, sales, inventory, and receipt data of each facility. For example, for facility A, processor 210 may collect monthly inbound pieces from each upstream facility of facility A, i.e., facilities B, E, F, and G, via inbound links represented T-A-B, T-A-E, T-A-F, and T-A-G, respectively, over a historical period of time. Processor 210 may also collect, for facility A, monthly outbound pieces to each downstream facility of facility A, i.e., facilities B, E, and F, via non-revenue outbound links F-A-B, F-A-E, and F-A-F, respectively, over the historical period of time. Processor 210 may also collect, for facility A, monthly total inbound lines received by facility A, and monthly total outbound non-revenue lines and monthly total outbound revenue lines sent from facility A, over the historical period of time. For example, the historical and future demand, sales, inventory, and receipt data of facility A may include monthly demand, monthly gross sales, monthly regional sales, monthly receipt, monthly ending inventory level, and monthly minimum and maximum inventory levels, etc., over the historical period of time and over a future period of time. The collected data may be in the units of dollars, pieces, and/or weight. Processor 210 may collect this data from one or more external databases 270, which may be associated with a marketing department of the business organization. Alternatively, a user may manually collect this data from the marketing department and input these data to system 200.

Processor 210 may then forecast total inbound pieces for each facility from all of its upstream facilities (step 308). In one embodiment, processor 210 may forecast, for each facility, the total inbound pieces to be received by that facility based on the historical total inbound lines of that facility, and the historical and future demand, sales, inventory, and receipt data of that facility. For example, for facility A, processor 210 may forecast total inbound pieces from all of its upstream facilities B, E, F, and G, via inbound links T-A-B, T-A-E, T-A-F, and T-A-G, respectively. Processor 210 may perform the forecasting by using a multiple regression approach.

Once processor 210 has forecasted the total inbound pieces for each facility in step 308, processor 210 may forecast, for each facility, the inbound pieces to be received from each one of the upstream facilities of that facility (step 312). In one embodiment, processor 210 may forecast, for each facility, the inbound pieces to be received by that facility from each upstream facility of that facility, based on the forecasted total inbound pieces of that facility, the historical inbound pieces from each upstream facility of that facility, and the historical and future demand, sales, inventory, and receipt data of each facility. For example, processor 210 may forecast, for facility A, the monthly inbound pieces to be received from each of upstream facilities B, E, F, and G over a future period of time. That is, based on the forecasted result, facility A may receive 15%, 30%, 25%, and 40% of the total inbound pieces during Month−1 in the future from its upstream facilities B, E, F, and G, respectively. Processor 210 may perform the forecasting by using a Dirichlet regression model.

Processor 210 may then forecast, for each facility, the total inbound lines to be received from all of the upstream facilities of that facility (step 316). In one embodiment, processor 210 may forecast the total inbound lines for each facility based on the forecasted inbound pieces from each upstream facility of that facility, the collected historical inbound lines of that facility, and the collected historical and forecasted demand, sales, inventory, and receipt data of that facility. For example, for facility A, processor 210 may forecast total inbound lines from all of its upstream facilities B, E, F, and G, via inbound links T-A-B, T-A-E, T-A-F, and T-A-G, respectively. Processor 210 may perform the forecasting by using a multiple regression approach.

Processor 210 may also forecast, for each facility, the total outbound non-revenue lines to be sent from that facility to all of its downstream facilities (step 320). In one embodiment, processor 210 may forecast the total outbound non-revenue lines for each facility based on historical and future outbound pieces from that facility to each of its downstream facilities, the historical and future outbound non-revenue lines of that facility, and the historical and forecasted demand, sales, inventory, and receipt data of that facility. For example, processor 210 may forecast, for facility A, the total outbound non-revenue lines to be sent from facility A to all of its downstream facilities B, E, and F. Processor 210 may perform the forecasting by using a multiple regression approach.

Processor 210 may further forecast, for each facility, the total outbound revenue lines to be sent from that facility to all of its dealers (step 324). In one embodiment, processor 210 may forecast, for each facility, total outbound revenue lines of that facility, based on the historical total outbound revenue lines of that facility, and the historical and future demand, sales, inventory, and receipt data of that facility. For example, processor 210 may forecast the outbound revenue lines to be sent from facility A to dealer A1. Processor 210 may forecast the total outbound revenue lines for each facility based on the collected historical outbound revenue lines of that facility, and the historical and forecasted demand, sales, inventory, and receipt data of that facility. Processor 210 may perform the forecasting by using a multiple regression approach.

Although in the embodiment illustrated in FIG. 3, processor 210 forecasts all of the total inbound lines, the total outbound non-revenue lines, and the total outbound revenue lines for each facility, process 300 is not so limited. That is, processor 210 may forecast one or two of the total inbound lines, the total outbound non-revenue lines, and the total outbound revenue lines for each facility. Moreover, the sequence of the steps in process 300 is not limited to the embodiment illustrated in FIG. 3. For example, processor 210 may forecast the total outbound revenue lines before forecasting the total outbound non-revenue lines and forecasting the total inbound lines. For another example, processor 210 may forecast the total outbound non-revenue lines before forecasting the total inbound lines.

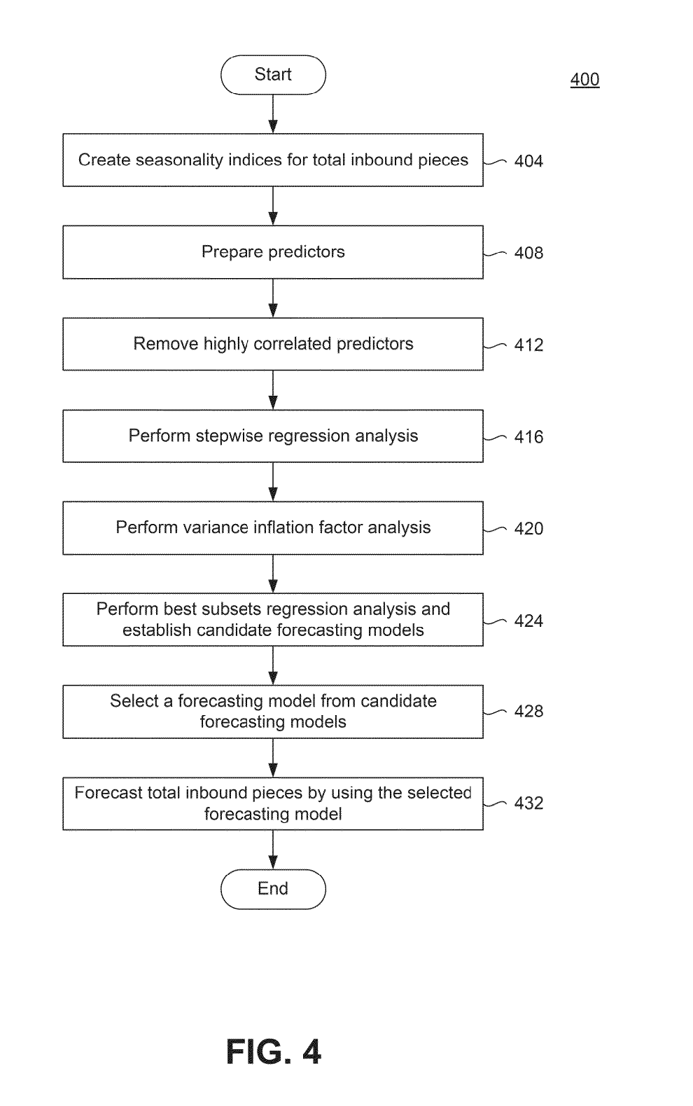

FIG. 4 illustrates a flowchart of an exemplary process 400 of forecasting the total inbound pieces to be received by facility A from upstream facilities B, E, F, and G, according to a disclosed embodiment. Referring to FIG. 4, processor 210 may create monthly seasonality indices for total inbound pieces received by facility A (step 404). The monthly seasonality indices for total inbound pieces represent the cyclic variation of the total inbound pieces over a historical period of time, and into a future period of time. Processor 210 may calculate the monthly seasonality indices for the total inbound pieces based on the monthly total inbound pieces received by facility A over a historical period of time, e.g., the past five years. For example, a seasonality index of the total inbound pieces received by facility A for January may be calculated as the average total inbound pieces received by facility A in January over the past five years, divided by average yearly total inbound pieces.

Processor 210 may prepare a group of predictors based on the monthly seasonality indices for total inbound pieces received by facility A, and the historical and forecasted demand, sales, inventory, and receipt data of facility A (step 408). For example, the historical and forecasted demand, sales, inventory, and receipt data of facility A may include monthly demand, monthly sales, monthly receipt, monthly ending inventory level, and monthly minimum and maximum inventory levels, over the historical period of time and over a future period of time. Each of the monthly demand, monthly sales, monthly receipt, monthly ending inventory level, and monthly minimum and maximum inventory levels may constitute one of the group of predictors. In addition, the monthly seasonality indices may constitute one of the group of predictors.

Processor 210 may remove highly correlated predictors from the group of predictors (step 412). For example, processor 210 may analyze each pair of predictors, and determine whether the predictors are highly correlated with each other. If they are highly correlated, processor 210 may randomly remove one of the two highly correlated predictors. For example, processor 210 may determine whether the two predictors are highly correlated by calculating a Pearson correlation coefficient between the two predictors, and compare the Pearson correlation coefficient with a predetermined threshold value such as, for example, 0.9. When the Pearson correlation coefficient is greater than 0.9, processor 210 may determine that the two predictors are highly correlated, and may then remove one of the two predictors from the group of predictors.

Processor 210 may then perform stepwise regression analysis on the remaining predictors in the group to select predictors that are significant for total inbound pieces of facility A, and to remove predictors that are not significant for the total inbound pieces of facility A (step 416). During the stepwise regression analysis, processor 210 may build a linear regression model for fitting the historical total inbound pieces based on a subset of predictors, and enter and remove predictors, in a stepwise manner, into the model until there is no reason (e.g., no room for improvement) to enter or remove any more predictors into the model. For example, processor 210 may set an alpha significance level to no more than 0.05. Processor 210 may then perform the stepwise regression analysis until adding an additional predictor into the subset of predictor does not yield a probability value (P-value) below the alpha significance level. Processor 210 may select the final set of predictors upon which the regression model is built, and remove the remaining predictors from the group of predictors.

Processor 210 may perform variance inflation factor (VIF) analysis on the group of predictors to remove predictors that are highly collinear (step 420). The VIF of a predictor may represent the scale of correlation between the predictor and all of the other predictors in the group for a given regression model. During the VIF analysis, processor 210 may establish a first linear regression model for the total inbound pieces based on all of the predictors in the group, and calculate a VIF of each predictor for the first linear regression model. Processor 210 may remove one or more predictors from the group if their VIFs exceed a first VIF threshold value such as, for example, 5. Processor 210 may then establish another linear regression model based on the remaining predictors, and remove one or more predictors if their VIFs exceed a second VIF threshold value (e.g., 2) which is lower than the first VIF threshold value. Processor 210 may repeat the above-described process until all of the VIFs of the predictors are below a VIF threshold value. Processor 210 may select the final predictors, and remove the remaining ones, which are highly collinear, from the group.

Processor 210 may perform best subsets regression analysis on the group of predictors to select a predetermined number of subsets of predictors, and to establish candidate forecasting models based on the selected subsets of predictors (step 424). Processor 210 may select the predetermined number (e.g., four) of best subsets of predictors that meet one or more objective criterion, such as having the largest adjusted R² value and/or the smallest mean squared error (MSE). For example, processor 210 may establish a plurality of possible linear regression models for fitting the historical total inbound pieces of facility A based on all of the possible combinations of the predictors. Suppose there are n predictors represented by x₁(t), x₂(t), . . . , xₙ(t). Processor 210 may establish a plurality of linear regression models based on each predictor, each linear regression model being represented by,

y(t)=A+Bxₐ(t)

where xₐ(t) is one of the n predictors x₁(t), x₂(t), . . . , xₙ(t), A and B are constant values calculated by processor 210, and y(t) is the historical monthly total inbound pieces of facility A. Processor 210 may also establish a plurality of linear regression models based on a combination of two predictors selected from the n predictors, each linear regression model being represented by,

y(t)=A+Bxₐ(t)+Cx_{b}(t)

where xₐ(t) and x_{b}(t) are two predictors selected from the n predictors x₁(t), x₂(t), . . . , xₙ(t), and A, B, and C are constant values calculated by processor 210. Processor 210 may also establish a plurality of linear regression models based on combinations of three, four, . . . or n predictors. Processor 210 may then analyze each of the possible linear regression models, and select the four best linear regression models that have the largest adjusted R² value and the smallest MSE. Processor 210 may select the four subsets of predictors for building the four best linear regression models, respectively, as the four best subsets of predictors. Processor 210 may also set the four best linear regression models as candidate forecasting models.

Processor 210 may select a forecasting model from the candidate forecasting models established during the best subsets regression analysis (Step 428). Processor 210 may select the forecasting model based on one or more criteria. For example, processor 210 may select the forecasting model whose adjusted R² value falls within a predetermined range, e.g., 65%≦adjusted R̂2 value≦85%. Processor 210 may also select the forecasting model based on a statistical significance factor of each of the predictors in the candidate forecasting models. For example, each predictor in the candidate forecasting model should have a p-value less than 0.05. Processor 210 may also select the forecasting model based on one or more of analyzing p-value, F-statistics value, and minimum residuals. In some embodiments, processor 210 may present at least one of the adjusted R̂2 value, p-value, F-statistics value, and minimum residuals on a display screen, such that a user may intelligently evaluate these values and select the forecasting model that has the optimum condition. The selected forecasting model may be a linear regression model.

Processor 210 may then forecast the total inbound pieces to be received by facility A by using the selected forecasting model (step 432). For example, processor 210 may forecast monthly total inbound pieces to be received by facility A over a future period of time (e.g., future 12 months). Processor 210 may then end process 400 of forecasting total inbound pieces for facility A. Processor 210 may perform a process similar to process 400 for each one of facilities B, C, . . . H, for forecasting total inbound pieces to be received by that facility.

Although in the embodiment illustrated in FIG. 4, process 400 includes step 412 of removing highly correlated predictors, step 416 of performing stepwise regression analysis, and step 420 of performing variance inflation factoranalysis, process 400 is not so limited. That is, process 400 may include one or more of steps 412, 416, and 420. In addition, the process may include one or more additional analysis steps for selecting the predictors. Moreover, the sequence of the steps in process 400 is not limited to the embodiment illustrated in FIG. 4. For example, step 420 may be performed before step 416.

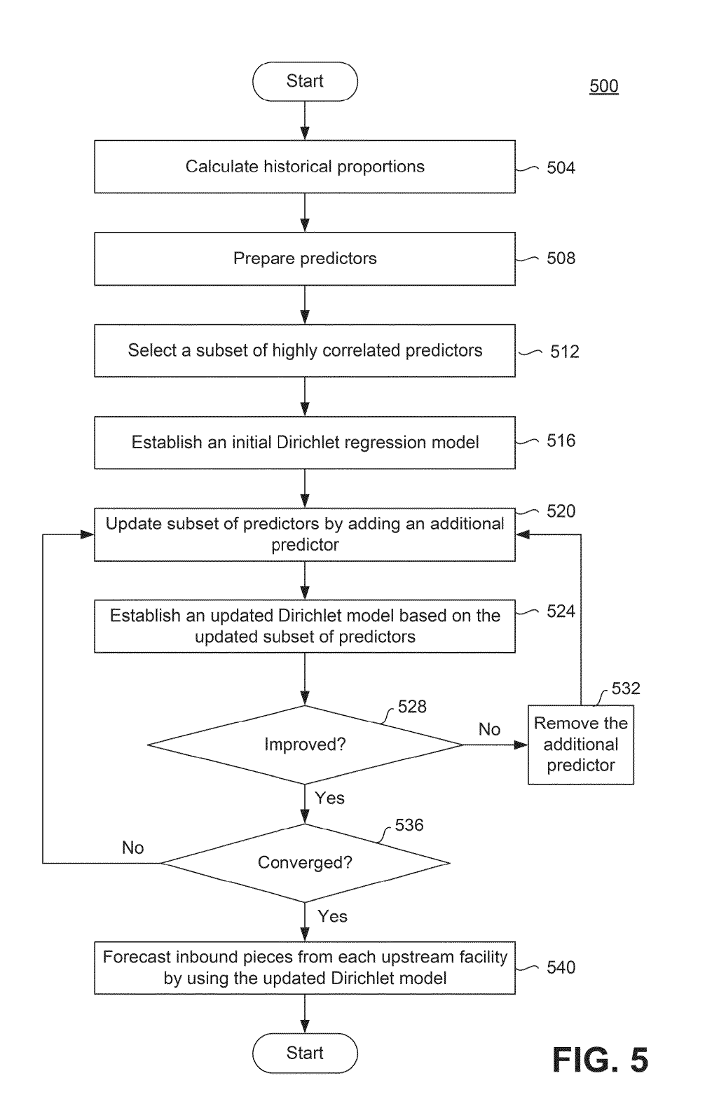

FIG. 5 illustrates a flowchart of an exemplary process 500 of forecasting the inbound pieces to be received by facility A from each one of upstream facilities B, E, F, and G, according to a disclosed embodiment. Referring to FIG. 5, processor 210 may first calculate historical proportions (%) of total inbound pieces received by facility A from each one of upstream facilities B, E, F, and G (step 504). Processor 210 may calculate monthly proportions of total inbound pieces based on the monthly inbound pieces from each one of upstream facilities B, E, F, and G over a historical period of time. For example, for a historical Month 1, the portion P_{B} (%) of total inbound pieces received by facility A from upstream facility B is calculated by P_{B} (%)=IB_{B}/(IB_{B}+IB_{E}+IB_{F}+IB_{G}), where IB_{B}, IB_{E}, IB_{F}, and IB_{G} represent the inbound pieces respectively received from upstream facilities B, E, F, and G during Month 1.

Processor 210 may then prepare a group of predictors based on the collected data associated with facility A (step 508). For example, processor 210 may prepare the predictors based on the collected historical and forecasted demand, sales, inventory, and receipt data of facility A. For example, the historical and forecasted demand, sales, inventory, and receipt data of facility A may include monthly demand, monthly sales, monthly receipt, monthly ending inventory level, and monthly minimum and maximum inventory levels, over the historical period of time and over a future period of time. Each of the monthly demand, monthly sales, monthly receipt, monthly ending inventory level, and monthly minimum and maximum inventory levels may constitute one of the group of predictors.

Processor 210 may select a subset of two or three highly correlated predictors (step 512). For example, processor 210 may analyze each pair of predictors in the group of predictors to identify one or more highly correlated pair of predictors. For example, processor 210 may determine whether the two predictors are highly correlated based on a Pearson correlation coefficient between the two predictors. Once the highly correlated pairs of predictors are identified, processor 210 may then analyze one predictor in each of the highly correlated pairs with each one of other predictors in the group, to identify one or more other predictors that are correlated with the one predictor. Processor 210 may select the predictors in the highly correlated pairs and the one or more identified predictor to create the subset of highly correlated predictors.

Processor 210 may establish an initial Dirichlet regression model based on the subset of highly correlated predictors (step 516). The outcome of the Dirichlet regression model is fitted historical proportions (%) of total inbound pieces received by facility A from each one of upstream facilities B, E, F, and G. Once the initial Dirichlet regression model is established, processor 210 may calculate a log-likelihood ratio of the initial Dirichlet regression model.

Processor 210 may update the subset of predictors by adding an additional predictor selected from the remaining predictors in the group (step 520). Processor 210 may then establish an updated Dirichlet regression model based on the updated subset of predictors (step 524). Once the updated Dirichlet regression model is established, processor 210 may calculate a log-likelihood ratio of the updated Dirichlet regression model.

Processor 210 may determine whether the updated Dirichlet regression model has improved over the previous Dirichlet regression model (step 528). For example, processor 210 may determine whether the updated Dirichlet regression model has improved by comparing the log-likelihood ratio of the updated Dirichlet regression model to that of the previous Dirichlet regression model. If the log-likelihood ratio of the updated Dirichlet regression model is greater than that of the previous Dirichlet regression model, processor 210 may determine that the updated Dirichlet regression model has improved. If the updated Dirichlet regression model has not improved (step 528, No), processor 210 may remove the last-added additional predictor from the subset of predictors (step 532). Processor 210 may then return back to step 520 to update the subset of predictors by adding another predictor.

Otherwise, if the updated Dirichlet regression model has improved (step 528, Yes), processor 210 may determine whether the updated Dirichlet regression model has converged (step 536). For example, processor 210 may determine whether the updated Dirichlet regression model has converged by comparing the log-likelihood ratio of the updated Dirichlet regression model to a predetermined threshold value. If the log-likelihood ratio is greater than the predetermined threshold value, processor 210 may determine that the updated Dirichlet regression model has converged. If processor 210 determines that the updated Dirichlet regression model has not converged (step 536, No), processor 210 may return to step 520 to update the subset of predictors by adding another predictor.

Otherwise, if processor 210 determines that the updated Dirichlet regression model has converged (step 536, Yes), processor 210 may forecast proportions of the total inbound pieces to be received by facility A from each one of upstream facilities B, E, F, and G, by using the last-updated Dirichlet regression model (step 540). Processor 210 may then end process 500. Processor 210 may a process similar to process 500 for each one of facilities B, C, . . . H.

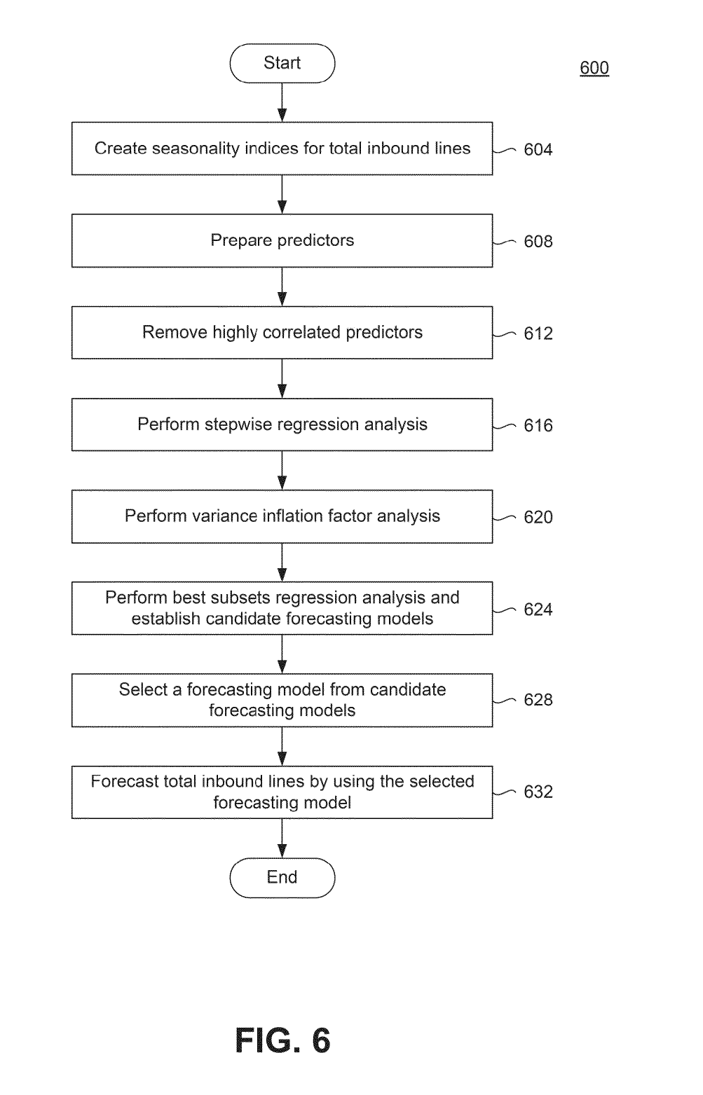

FIG. 6 illustrates a flowchart of an exemplary process 600 of forecasting the total inbound lines to be received by facility A from upstream facilities B, E, F, and G, according to a disclosed embodiment. Referring to FIG. 6, processor 210 may first create monthly seasonality indices for total inbound lines received by facility A (step 604). Processor 210 may calculate the monthly seasonality indices for total inbound lines received by facility A based on the monthly total inbound lines received by facility A over a historical period of time, e.g., the past five years. For example, a seasonality index for the total inbound lines received by facility A for January may be calculated as the average total inbound lines received by facility A in January over the past five years, divided by average yearly total inbound lines received by facility A.

Processor 210 may prepare a group of predictors based on the historical and forecasted inbound pieces from each upstream facility of facility A, the monthly seasonality indices for total inbound lines received by facility A, and the historical and forecasted demand, sales, inventory, and receipt data of facility A (step 608). For example, the historical and forecasted inbound pieces from upstream facility B may constitute one of the group of predictors; the historical and forecasted inbound pieces from upstream facility E may constitute another one of the group of predictors; and so one. Each of the monthly demand, monthly sales, monthly receipt, monthly ending inventory level, and monthly minimum and maximum inventory levels may constitute one of the group of predictors. In addition, the monthly seasonality indices may constitute one of the group of predictors.

Processor 210 may remove highly correlated predictors from the group of predictors (step 612). For example, processor 210 may analyze each pair of predictors, and determine whether the predictors are highly correlated with each other. If they are highly correlated, processor 210 may randomly remove one of the two highly correlated predictors.

Processor 210 may then perform stepwise regression analysis on the remaining predictors in the group to select predictors that are significant for total inbound lines of facility A (step 616). During the stepwise regression analysis, processor 210 may build a linear regression model for fitting the historical total inbound lines from a subset of predictors, and enter and remove predictors, in a stepwise manner, into the model until there is no reason (e.g., no room for improvement) to enter or remove any more predictors into the model.

Processor 210 may perform variance inflation factor (VIF) analysis on the group of predictors to remove predictors that are highly collinear (step 620). The VIF of a predictor may represent the scale of correlation between the predictor and all of the other predictors in the group for a given regression model. During the VIF analysis, processor 210 may establish a first linear regression model for fitting the historical total inbound lines based on all of the predictors in the group, and calculate a VIF of each predictor for the first linear regression model. Processor 210 may remove one or more predictors from the group if their VIFs exceed a first VIF threshold value such as, for example, 5. Processor 210 may then establish another linear regression model based on the remaining predictors, and remove one or more predictors if their VIFs exceed a second VIF threshold value (e.g., 2) which is lower than the first VIF threshold value. Processor 210 may repeat the above-described process until all of the VIFs of the predictors are below a VIF threshold value. Processor 210 may select the final predictors, and remove the remaining ones, which are highly collinear, from the group.

Processor 210 may perform best subsets regression analysis on the group of predictors to select a predetermined number of subsets of predictors, and establish candidate forecasting models based on the selected subsets of predictors (step 624). Processor 210 may select the predetermined number (e.g., four) of best subsets of predictors that meet one or more objective criterion, such as having the largest adjusted R² value and/or the smallest mean squared error (MSE). For example, processor 210 may establish a plurality of possible linear regression models for fitting the historical total inbound lines of facility A based on all of the possible combinations of the predictors. Processor 210 may then analyze each of the possible linear regression models, and select the four best linear regression models that have the largest adjusted R² value and the smallest MSE. Processor 210 may select the four subsets of predictors for building the four best linear regression models, respectively, as the four best subsets of predictors. Processor 210 may also set the four best linear regression models as candidate forecasting models.

Processor 210 may select a forecasting model from the candidate forecasting models established during the best subsets regression analysis (Step 628). Processor 210 may select the forecasting model based on one or more criteria. For example, processor 210 may select the forecasting model whose adjusted R² value falls within a predetermined range, e.g., 65%≦adjusted R̂2 value≦85%. Processor 210 may also select the forecasting model based on a statistical significance factor of each of the predictors in the candidate forecasting models. For example, each predictor in the candidate forecasting model should have a p-value less than 0.05. Processor 210 may also select the forecasting model based on one or more of analyzing p-value, F-statistics value, and minimum residuals.

Processor 210 may then forecast the total inbound lines to be received by facility A by using the selected forecasting model (632). For example, processor 210 may forecast monthly total inbound lines to be received by facility A over a future period of time (e.g., future 12 months). Processor 210 may then end process 600 of forecasting total inbound lines for facility A. Processor 210 may perform a process similar to process 600 for each one of facilities B, C, . . . H, for forecasting total inbound lines to be received by that facility.

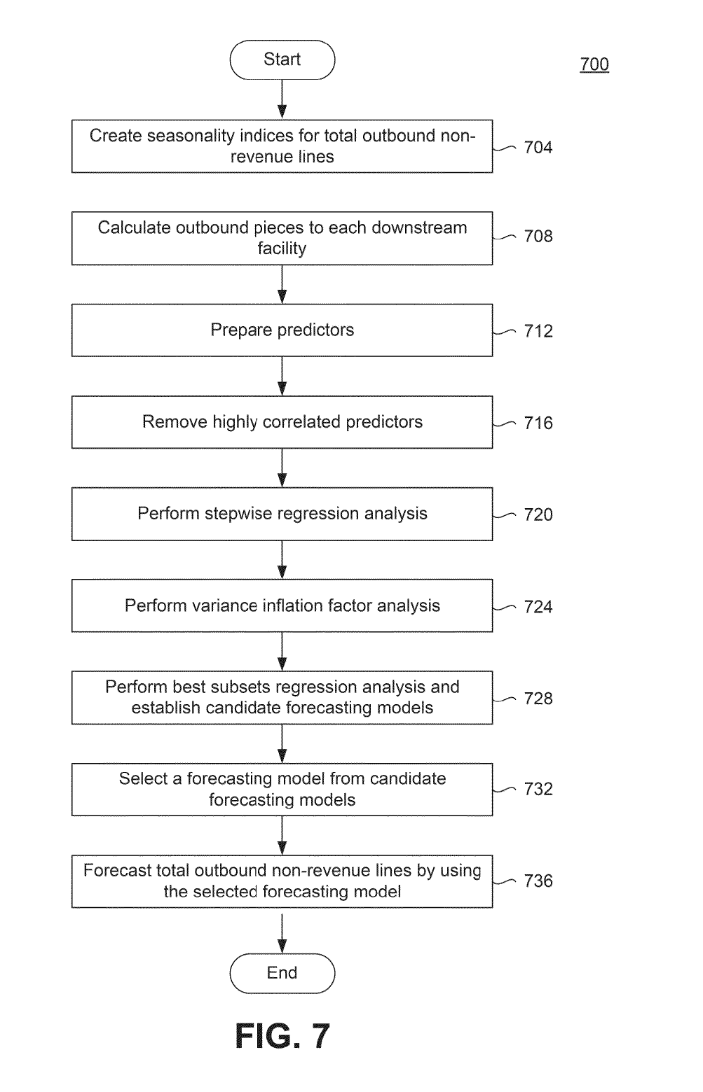

FIG. 7 illustrates a flowchart of an exemplary process 700 of forecasting the total outbound non-revenue lines to be sent from facility A to all of downstream facilities B, E, and F, according to a disclosed embodiment. Referring to FIG. 7, processor 210 may first create monthly seasonality indices for total outbound non-revenue lines sent from facility A (step 704). Processor 210 may calculate the monthly seasonality indices for total outbound non-revenue lines sent from facility A based on the monthly total outbound non-revenue lines sent from facility A over a historical period of time. For example, a seasonality index for the total outbound non-revenue lines sent from facility A for January may be calculated as the average total outbound non-revenue lines sent from facility A in January over the past five years, divided by average yearly total outbound non-revenue lines sent from facility A.

Processor 210 may also calculate the historical and forecasted outbound pieces to be sent from facility A to each of downstream facilities B, E, and F (step 708). Processor 210 may calculate this data based on the historical and forecasted inbound pieces received by each of downstream facilities B, E, and F from facility A. For example, the outbound pieces from facility A to facility B equal the inbound pieces received by facility B from facility A. Similarly, the outbound pieces from facility A to facility E equal the inbound pieces received by facility E from facility A.

Processor 210 may prepare a group of predictors based on the historical and forecasted outbound pieces to be sent from facility A to each of downstream facilities B, E, and F, the monthly seasonality indices for total outbound non-revenue lines sent from facility A, and the historical and forecasted demand, sales, inventory, and receipt data of facility A (step 712). For example, the historical and forecasted outbound pieces sent from facility A to downstream facility B may constitute one of the group of predictors; the historical and forecasted outbound pieces sent from facility A to downstream facility E may constitute another one of the group of predictors; and so one. Each of the monthly demand, monthly sales, monthly receipt, monthly ending inventory level, and monthly minimum and maximum inventory levels may constitute one of the group of predictors. In addition, the monthly seasonality indices may constitute one of the group of predictors.

Processor 210 may remove highly correlated predictors from the group of predictors (step 716). For example, processor 210 may analyze each pair of predictors, and determine whether the predictors are highly correlated with each other. If they are highly correlated, processor 210 may randomly remove one of the two highly correlated predictors.

Processor 210 may then perform stepwise regression analysis on the remaining predictors in the group to select predictors that are significant for total outbound non-revenue lines of facility A (step 720). During the stepwise regression analysis, processor 210 may build a linear regression model for fitting the historical total outbound non-revenue lines based on a subset of predictors, and enter and remove predictors, in a stepwise manner, into the model until there is no reason (e.g., no room for improvement) to enter or remove any more predictors into the model.

Processor 210 may perform variance inflation factor (VIF) analysis on the group of predictors to remove predictors that are highly collinear (step 724). The VIF of a predictor may represent the scale of correlation between the predictor and all of the other predictors in the group for a given regression model. During the VIF analysis, processor 210 may establish a first linear regression model for fitting the historical total outbound non-revenue lines based on all of the predictors in the group, and calculate a VIF of each predictor for the first linear regression model. Processor 210 may remove one or more predictors from the group if their VIFs exceed a first VIF threshold value such as, for example, 5. Processor 210 may then establish another linear regression model based on the remaining predictors, and remove one or more predictors if their VIFs exceed a second VIF threshold value (e.g., 2) which is lower than the first VIF threshold value. Processor 210 may repeat the above-described process until all of the VIFs of the predictors are below a VIF threshold value. Processor 210 may select the final predictors, and remove the remaining ones, which are highly collinear, from the group.

Processor 210 may perform best subsets regression analysis on the group of predictors to select a predetermined number of subsets of predictors, and establish candidate forecasting models based on the selected subsets of predictors (step 728). Processor 210 may select the predetermined number (e.g., four) of best subsets of predictors that meet one or more objective criterion, such as having the largest adjusted R² value and/or the smallest mean squared error (MSE). For example, processor 210 may establish a plurality of possible linear regression models for fitting the historical total outbound non-revenue lines of facility A based on all of the possible combinations of the predictors. Processor 210 may then analyze each of the possible linear regression models, and select the four best linear regression models that have the largest adjusted R² value and the smallest MSE. Processor 210 may select the four subsets of predictors for building the four best linear regression models, respectively, as the four best subsets of predictors. Processor 210 may also set the four best linear regression models as candidate forecasting models.

Processor 210 may select a forecasting model from the candidate forecasting models established during the best subsets regression analysis (Step 732). Processor 210 may select the forecasting model based on one or more criteria. For example, processor 210 may select the forecasting model whose adjusted R² value falls within a predetermined range, e.g., 65%≦adjusted R̂2 value≦85%. Processor 210 may also select the forecasting model based on a statistical significance factor of each of the predictors in the candidate forecasting models. For example, each predictor in the candidate forecasting model should have a p-value less than 0.05. Processor 210 may also select the forecasting model based on one or more of analyzing p-value, F-statistics value, and minimum residuals.

Processor 210 may then forecast the total outbound non-revenue lines of facility A by using the selected forecasting model (step 736). For example, processor 210 may forecast monthly total outbound non-revenue lines to be sent from facility A over a future period of time (e.g., future 12 months). Processor 210 may then end process 700 of forecasting total outbound non-revenue lines for facility A. Processor 210 may perform a process similar to process 700 for each one of facilities B, C, . . . H, for forecasting total outbound non-revenue lines to be sent from that facility.

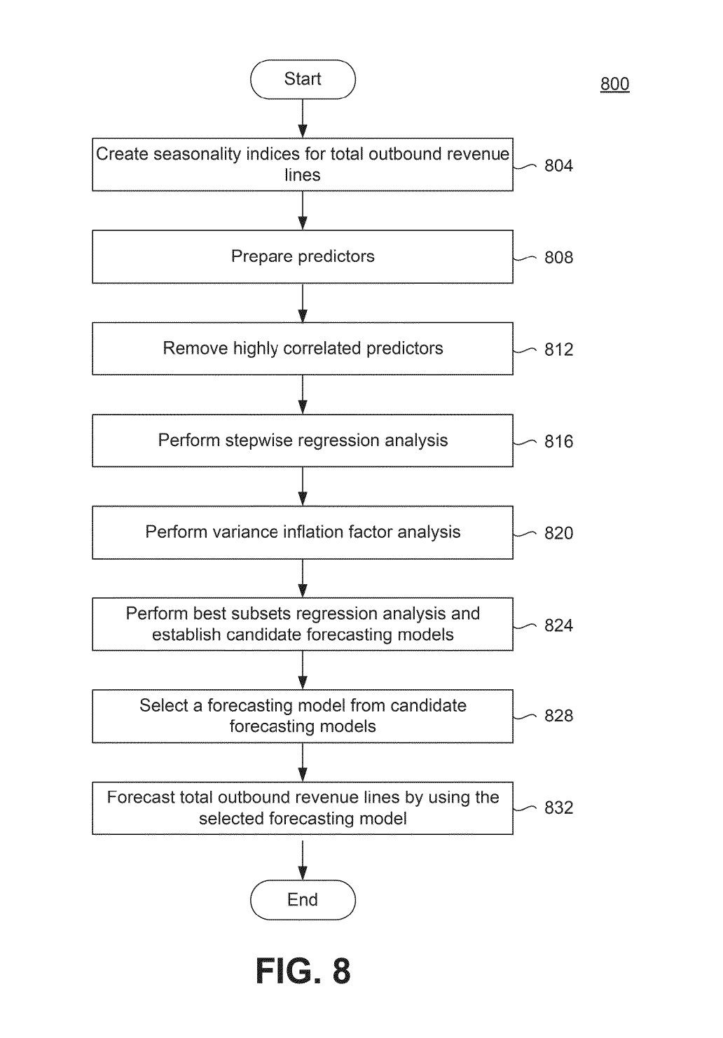

FIG. 8 illustrates a flowchart of an exemplary process 800 of forecasting the total outbound revenue lines to be sent from facility A to dealer A1. Referring to FIG. 8, processor 210 may first create monthly seasonality indices for total outbound revenue lines sent from facility A to dealer A1 (step 804). Processor 210 may calculate the monthly seasonality indices for total outbound revenue lines sent from facility A to dealer A1 based on the monthly total outbound revenue lines sent from facility A to dealer A1 over a historical period of time. For example, a seasonality index for the total outbound revenue lines sent from facility A to dealer A1 for January may be calculated as the average total outbound revenue lines sent from facility A to dealer A1 in January over the past five years, divided by average yearly total outbound revenue lines sent from facility A to dealer A1.

Processor 210 may then prepare a group of predictors based on the historical and forecasted demand, sales, inventory, and receipt data of facility A (step 808). For example, each of the monthly demand, monthly sales, monthly receipt, monthly ending inventory level, and monthly minimum and maximum inventory levels may constitute one of the group of predictors. In addition, the monthly seasonality indices may constitute one of the group of predictors.

Processor 210 may remove highly correlated predictors from the group of predictors (step 812). For example, processor 210 may analyze each pair of predictors, and determine whether the predictors are highly correlated with each other. If they are highly correlated, processor 210 may randomly remove one of the two highly correlated predictors.

Processor 210 may then perform stepwise regression analysis on the remaining predictors in the group to select predictors that are significant for total outbound non-revenue lines of facility A (step 816). During the stepwise regression analysis, processor 210 may build a linear regression model for fitting the historical total outbound revenue lines based on a subset of predictors, and enter and remove predictors, in a stepwise manner, into the model until there is no reason (e.g., no room for improvement) to enter or remove any more predictors into the model.

Processor 210 may perform variance inflation factor (VIF) analysis on the group of predictors to remove predictors that are highly collinear (step 820). The VIF of a predictor may represent the scale of correlation between the predictor and all of the other predictors in the group for a given regression model. During the VIF analysis, processor 210 may establish a first linear regression model for fitting the historical total outbound revenue lines based on all of the predictors in the group, and calculate a VIF of each predictor for the first linear regression model. Processor 210 may remove one or more predictors from the group if their VIFs exceed a first VIF threshold value such as, for example, 5. Processor 210 may then establish another linear regression model based on the remaining predictors, and remove one or more predictors if their VIFs exceed a second VIF threshold value (e.g., 2) which is lower than the first VIF threshold value. Processor 210 may repeat the above-described process until all of the VIFs of the predictors are below a VIF threshold value. Processor 210 may select the final predictors, and remove the remaining ones, which are highly collinear, from the group.

Processor 210 may perform best subsets regression analysis on the group of predictors to select a predetermined number of subsets of predictors, and establish candidate forecasting models based on the selected subsets of predictors (step 824). Processor 210 may select the predetermined number (e.g., four) of best subsets of predictors that meet one or more objective criterion, such as having the largest adjusted R² value and/or the smallest mean squared error (MSE). For example, processor 210 may establish a plurality of possible linear regression models for fitting the historical total outbound revenue lines of facility A based on all of the possible combinations of the predictors. Processor 210 may then analyze each of the possible linear regression models, and select the four best linear regression models that have the largest adjusted R² value and the smallest MSE. Processor 210 may select the four subsets of predictors for building the four best linear regression models, respectively, as the four best subsets of predictors. Processor 210 may also set the four best linear regression models as candidate forecasting models.

Processor 210 may select a forecasting model from the candidate forecasting models established during the best subsets regression analysis (Step 828). Processor 210 may select the forecasting model based on one or more criteria. For example, processor 210 may select the forecasting model whose adjusted R² value falls within a predetermined range, e.g., 65%≦adjusted R̂2 value≦85%. Processor 210 may also select the forecasting model based on a statistical significance factor of each of the predictors in the candidate forecasting models. For example, each predictor in the candidate forecasting model should have a p-value less than 0.05. Processor 210 may also select the forecasting model based on one or more of analyzing p-value, F-statistics value, and minimum residuals.

Processor 210 may then forecast the total outbound revenue lines of facility A by using the selected forecasting model (step 832). For example, processor 210 may forecast monthly total outbound revenue lines to be sent from facility A to dealer A1 over a future period of time (e.g., future 12 months). Processor 210 may then end process 800 of forecasting total outbound revenue lines for facility A. Processor 210 may perform a process similar to process 800 for each one of facilities B, C, . . . H, for forecasting total outbound non-revenue lines to be sent from that facility.

### INDUSTRIAL APPLICABILITY

According to the above exemplary embodiments, the disclosed lines forecasting system may forecast, for each facility in a facility network, inbound pieces to be received from each upstream facility of that facility, and may forecast total inbound lines and total outbound lines (including outbound non-revenue lines and outbound revenue lines) of each facility based on the forecasted inbound pieces from each upstream facility. Therefore, the disclosed lines forecasting system may provide accurate forecast data for each facility. Based on such forecast data, an effective service and operation planning may be achieved. In addition, the forecast data of each facility provided by the disclosed lines forecasting system may be consistent with that of the other facilities in the facility network.

Moreover, the disclosed lines forecasting system may forecast the total inbound lines and total outbound lines based on future demand, sales, inventory, and receipt data of each facility that have been forecasted based on one or more business goals of the entire business organization. Therefore, the forecast data of each facility provided by the disclosed lines forecasting system may be aligned with the business goals of the entire business organization.

It will be apparent to those skilled in the art that various modifications and variations can be made to the disclosed lines forecasting system. Other embodiments will be apparent to those skilled in the art from consideration of the specification and practice of the disclosed lines forecasting system. It is intended that the specification and examples be considered as exemplary only, with a true scope being indicated by the following claims and their equivalents.

What is claimed is:

1. A computer system for forecasting lines in a facility network, the computer system comprising:
at least one processor configured with instructions to:
collect data associated with each facility, the collected data including historical inbound pieces from each upstream facility of each facility, historical total inbound lines of each facility, and historical and future demand, sales, inventory, and receipt data of each facility;
forecast, for each facility, total inbound pieces to be received by that facility, based on the historical total inbound lines of that facility, and the historical and future demand, sales, inventory, and receipt data of that facility;
forecast, for each facility, inbound pieces to be received by that facility from each upstream facility of that facility, based on the forecasted total inbound pieces of that facility, the historical inbound pieces from each upstream facility of that facility, and the historical and future demand, sales, inventory, and receipt data of that facility; and
forecast, for each facility, total inbound lines to be received by that facility, based on the historical and forecasted inbound pieces received by that facility from each upstream facility of that facility, and the historical and future demand, sales, inventory, and receipt data of that facility.

2. The computer system of claim 1, wherein the at least one processor is configured to forecast, for each facility, total inbound pieces to be received by that facility, by using a multiple regression approach.

3. The computer system of claim 2, wherein, in a step of forecasting total inbound pieces to be received by a first facility, the at least one processor is configured to:
create monthly seasonality indices for total inbound pieces received by the first facility;
prepare a group of predictors based on the monthly seasonality indices for total inbound pieces received by the first facility, and the historical and future demand, sales, inventory, and receipt data of the first facility;
remove highly correlated predictors from the group of predictors;
perform stepwise regression analysis on the remaining predictors in the group to remove predictors that are not significant for the total inbound pieces of the first facility;
perform variance inflation factor (VIF) analysis on the remaining predictors in the group to remove predictors that are highly collinear;
perform best subsets regression analysis on the remaining predictors in the group of predictors to select a predetermined number of subsets of predictors, and to establish candidate forecasting models based on the selected subsets of predictors;
select a forecasting model from the candidate forecasting models; and
forecast the total inbound pieces to be received by the first facility by using the selected forecasting model.

4. The computer system of claim 1, wherein, in a step of forecasting inbound pieces to be received by a first facility from each upstream facility of the facility, the at least one processor is configured to:
calculate historical proportions of total inbound pieces received by the first facility from each upstream facility;
prepare a group of predictors based on the historical and future demand, sales, inventory, and receipt data of the first facility;
select a subset of highly correlated predictors from the group of predictors;
establish an initial Dirichlet regression model based on the subset of highly correlated predictors;
update the subset of predictors by adding an additional predictor selected from the remaining predictors in the group;
establish an updated Dirichlet regression model based on the updated subset of predictors;
determine whether the updated Dirichlet regression model has improved over the previous Dirichlet regression model;
based on a determination that the updated Dirichlet regression model has improved over the previous Dirichlet regression model, determine whether the updated Dirichlet regression model has converged; and
based on a determination that the updated Dirichlet regression model has converged, forecast proportions of the total inbound pieces to be received by the first facility from each upstream facility, by using the updated Dirichlet regression model.

5. The computer system of claim 4, wherein the at least one processor is further configured to:
based on a determination that the updated Dirichlet regression model has not improved over the previous Dirichlet regression model, remove the last-added additional predictor from the subset of predictors, and update the subset of predictors by adding another predictor selected from the remaining predictors in the group.

6. The computer system of claim 4, wherein the at least one processor is further configured to:
based on a determination that the updated Dirichlet regression model has not converged, update the subset of predictors by adding another predictor selected from the remaining predictors in the group.

7. The computer system of claim 4, wherein the at least one processor is further configured to:
determine that the updated Dirichlet regression model has improved over the previous Dirichlet regression model based on a determination that a log-likelihood ratio of the updated Dirichlet regression model is greater than a log-likelihood ratio of the previous Dirichlet regression model.

8. The computer system of claim 1, wherein the at least one processor is configured to forecast, for each facility, total inbound lines to be received by that facility, by using a multiple regression approach.

9. The computer system of claim 1, wherein, in a step of forecasting total inbound lines to be received by a first facility, the at least on processor is configured to:
create monthly seasonality indices for total inbound lines received by the first facility;
prepare a group of predictors based on the historical and forecasted inbound pieces from each upstream facility of the first facility, the monthly seasonality indices for total inbound lines received by the first facility, and the historical and future demand, sales, inventory, and receipt data of the first facility;
remove highly correlated predictors from the group of predictors;
perform stepwise regression analysis on the remaining predictors in the group to remove predictors that are not significant for the total inbound lines of the first facility;
perform variance inflation factor (VIF) analysis on the remaining predictors in the group to remove predictors that are highly collinear;
perform best subsets regression analysis on the remaining predictors in the group of predictors to select a predetermined number of subsets of predictors, and to establish candidate forecasting models based on the selected subsets of predictors;
select a forecasting model from the candidate forecasting models; and
forecast the total inbound lines to be received by the first facility by using the selected forecasting model.

10. The computer system of claim 1, wherein the collected data further includes historical total outbound non-revenue lines of each facility, and the at least one processor is further configured to:
forecast, for each facility, total outbound non-revenue lines of that facility, based on historical and future outbound pieces from that facility to each downstream facility, the historical total outbound non-revenue lines of that facility, and the historical and future demand, sales, inventory, and receipt data of that facility.

11. The computer system of claim 10, wherein the at least one processor is further configured to:
calculate, for each facility, the historical and future outbound pieces to each downstream facility of that facility based on the historical and forecasted inbound pieces received by each downstream facility from that facility.

12. The computer system of claim 10, wherein the at least one processor is configured to forecast, for each facility, total outbound non-revenue lines of that facility, by using a multiple regression approach.

13. The computer system of claim 1, wherein the collected data further includes historical total outbound revenue lines of each facility, and the at least one processor is further configured to:
forecast, for each facility, total outbound revenue lines of that facility, based on the historical total outbound revenue lines of that facility, and the historical and future demand, sales, inventory, and receipt data of that facility.

14. The computer system of claim 13, wherein the at least one processor is configured to forecast, for each facility, total outbound revenue lines of that facility, by using a multiple regression approach.

15. A method for forecasting lines in a facility network, the method comprising the following operations performed by at least one processor:
collecting data associated with each facility, the collected data including historical inbound pieces from each upstream facility of each facility, historical total inbound lines of each facility, and historical and future demand, sales, inventory, and receipt data of each facility;
forecasting, for each facility, total inbound pieces to be received by that facility, based on the historical total inbound lines of that facility, and the historical and future demand, sales, inventory, and receipt data of that facility;
forecasting, for each facility, inbound pieces to be received by that facility from each upstream facility of that facility, based on the forecasted total inbound pieces of that facility, the historical inbound pieces from each upstream facility of that facility, and the historical and future demand, sales, inventory, and receipt data of that facility; and
forecasting, for each facility, total inbound lines to be received by that facility, based on the historical and forecasted inbound pieces received by that facility from each upstream facility of that facility, and the historical and future demand, sales, inventory, and receipt data of that facility.

16. The method of claim 15, further including, in a step of forecasting total inbound pieces to be received by a first facility:
creating monthly seasonality indices for total inbound pieces received by the first facility;
preparing a group of predictors based on the monthly seasonality indices for total inbound pieces received by the first facility, and the historical and future demand, sales, inventory, and receipt data of the first facility;
removing highly correlated predictors from the group of predictors;
performing stepwise regression analysis on the remaining predictors in the group to remove predictors that are not significant for the total inbound pieces of the first facility;
performing variance inflation factor (VIF) analysis on the remaining predictors in the group to remove predictors that are highly collinear;
performing best subsets regression analysis on the remaining predictors in the group of predictors to select a predetermined number of subsets of predictors, and to establish candidate forecasting models based on the selected subsets of predictors;
selecting a forecasting model from the candidate forecasting models; and
forecasting the total inbound pieces to be received by the first facility by using the selected forecasting model.

17. The method of claim 15, further including, in a step of forecasting inbound pieces to be received by a first facility from each upstream facility of the facility:
calculating historical proportions of total inbound pieces received by the first facility from each upstream facility;
preparing a group of predictors based on the historical and future demand, sales, inventory, and receipt data of the first facility;
selecting a subset of highly correlated predictors from the group of predictors;
establishing an initial Dirichlet regression model based on the subset of highly correlated predictors;
updating the subset of predictors by adding an additional predictor selected from the remaining predictors in the group;
establishing an updated Dirichlet regression model based on the updated subset of predictors;
determining whether the updated Dirichlet regression model has improved over the previous Dirichlet regression model;
based on a determination that the updated Dirichlet regression model has improved over the previous Dirichlet regression model, determining whether the updated Dirichlet regression model has converged; and
based on a determination that the updated Dirichlet regression model has converged, forecasting proportions of the total inbound pieces to be received by the first facility from each upstream facility, by using the updated Dirichlet regression model.

18. The method of claim 17, further including:
based on a determination that the updated Dirichlet regression model has not improved over the previous Dirichlet regression model, removing the last-added additional predictor from the subset of predictors, and updating the subset of predictors by adding another predictor selected from the remaining predictors in the group.

19. The method of claim 15, further including, in a step of forecasting total inbound lines to be received by a first facility:
creating monthly seasonality indices for total inbound lines received by the first facility;
preparing a group of predictors based on the historical and forecasted inbound pieces from each upstream facility of the first facility, the monthly seasonality indices for total inbound lines received by the first facility, and the historical and future demand, sales, inventory, and receipt data of the first facility;
removing highly correlated predictors from the group of predictors;
performing stepwise regression analysis on the remaining predictors in the group to remove predictors that are not significant for the total inbound lines of the first facility;
performing variance inflation factor (VIF) analysis on the remaining predictors in the group to remove predictors that are highly collinear;
performing best subsets regression analysis on the remaining predictors in the group of predictors to select a predetermined number of subsets of predictors, and to establish candidate forecasting models based on the selected subsets of predictors;
selecting a forecasting model from the candidate forecasting models; and
forecasting the total inbound lines to be received by the first facility by using the selected forecasting model.

20. A computer system for forecasting lines in a facility network, the computer system comprising:
at least one processor configured with instructions to:
collect data associated with each facility, the collected data of each facility including historical inbound pieces from each upstream facility of that facility, historical total outbound non-revenue lines of that facility, and historical and future demand, sales, inventory, and receipt data of that facility;
forecast, for each facility, total inbound pieces to be received by that facility, based on the historical total inbound lines of that facility, and the historical and future demand, sales, inventory, and receipt data of that facility;
forecast, for each facility, inbound pieces to be received by that facility from each upstream facility of that facility, based on the forecasted total inbound pieces of that facility, the historical inbound pieces from each upstream facility of that facility, and the historical and future demand, sales, inventory, and receipt data of that facility;
calculate, for each facility, historical and future outbound pieces from that facility to each downstream facility of that facility based on the historical and forecasted inbound pieces received by each downstream facility from that facility; and
forecast, for each facility, total outbound non-revenue lines of that facility, based on the historical and future outbound pieces from that facility to each downstream facility, the historical total outbound non-revenue lines of that facility, and the historical and future demand, sales, inventory, and receipt data of that facility.
